(19) United States
(12) Patent Application Publication
(10) Pub. No.: US 2007/0099494 A1
(43) Pub. Date: May 3, 2007

(54) VERTICAL PATCH PANEL

(76) Inventors: Eren Niazi, San Jose, CA (US); Marc Rotzow, San Jose, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/555,537

(22) Filed: Nov. 1, 2006

Related U.S. Application Data
(60) Provisional application No. 60/732,514, filed on Nov. 2, 2005.

(51) Int. Cl. H01R 13/60

(52) U.S. Cl. 439/540.1

(57) ABSTRACT

A patch panel is provided whereby the patch panel can be mounted vertically on a standard rack. The patch panel can contain a plurality of network ports for connecting at least two devices together. The vertical patch panels of the present invention allow for reduction of cable lengths, simplification of the layout,increases in port density, aesthetic benefit due to symmetry of cabling, and significant reduction of overall total cost of ownership.

### RELATED APPLICATION

This application claims a benefit of, and priority under 35 USC § 119(e) to U.S. Provisional Patent Application No. 60/732,514, filed on Nov. 2, 2005, the content of which is hereby incorporated by reference in its entirety.

### TECHNICAL FIELD

This invention relates to patch panels for computer systems and more particularly to the manner in which patch panels are laid out.

### BACKGROUND

A patch panel is generally a panel of ports that can connect various different pieces of equipment together. Patch panels can allow circuits, networks, servers, and other devices to be arranged and rearranged, connecting the various equipment via ports and cables. For example, patch panels can connect a local area network's (LAN's) servers and/or computers to each other and to the outside lines that enable the LAN to connect to the Internet or another wide area network (WAN).

Many servers/computers to be connected are provided as rack-mountable devices. For example, servers are commonly provided as 19-inch rack equipment that can be mounted on 19 inch-wide racks (see e.g., Electronic Industries Alliance 310-D, International Electrotechnical Commission 60297, and Deutsches Institut für Normung 41494 SC48D). Various different devices are designed to be placed in racks and are commonly referred to as rack-mounts, rack-mounted systems, rack mount chasses, sub-rack, shelf, and the like.

Rack heights are typically of dimensions from about 77 inches to about 84 inches, the widths are typically from about 19 inches to about 28 inches, and the depths range from about 24 inches to about 42 inches. However, other rack sizes are also possible.

The rack's mounting fixtures include at least two parallel metal strips, also referred to as rails, standing vertically. Generally, for the rack size described above, each strip is about 0.625 inches (15.875 mm) wide, separated by a gap of about 17.75 inches (450.85 mm), giving an overall rack width of about 19 inches (482.6 mm). The strips also generally have holes in them at regular intervals so that each hole is part of a horizontal pair with a center-to-center distance of about 18.3 inches (464.82 mm).

The holes in the strips are generally arranged vertically in repeating sets of three, with center-to-center separations of 0.5 inch (12.7 mm), 0.625 inch (15.875 mm), 0.625 inch (15.875 mm). The hole pattern thus repeats every 1.75 inches (44.45 mm).

Racks are also divided into regions, generally 1.75 inches in height, within which there are three complete hole pairs in a vertically symmetric pattern, the holes being centered 0.25 inch (6.35 mm), 0.875 inch (22.225 mm), and 1.5 inch (38.1 mm) from the top or bottom of the region. Such a region is commonly known as a “U”, for “unit”, and heights within racks are measured by this unit. Rack-mountable equipment is generally designed to occupy some integral number of U. For example, rack-mountable computers are most often 1U or 2U high.

Rack-mountable equipment (i.e., servers and the like) can be mounted simply by bolting its front panel to the rack or, with a square-holed rack, by clipping or some other variation of fastener. In some cases, a second pair of mounting strips located at the back of the equipment can be utilized to mount the equipment to the racks as well. Various different spacing between the front and back strips is used (e.g., 800 mm can be a typical spacing), and equipment is often designed to handle a range of rack depths.

Typically, patch panels are horizontally arranged at the top of the server racks and usually take up approximately 1U per 24 ports of connections. In addition, an extra 2U may be taken up by cable runs or spacers for the cables. FIG. 4A shows one example of such a prior art horizontal patch panel 400 on server rack 410. The lengths of cable used to connect machines therefore ranges from about 3 feet to about 14 feet. The typical shortest run of cable will be three feet to a machine at the top of the rack closest to the horizontal patch panel. This assumes that proper cable cleaning is performed, meaning that the cables are run through the cable runs, down the side and over to the machine. Generally, this run is approximately three feet and services only the uppermost servers. As cabling of the servers proceeds down the rack, the lengths of cables increase. Because a standard rack is about seven feet high, to go from the top patch panel to the servers closest to the ground, a minimum of about ten feet of cable can be needed. Moreover, some servers have cable runs mounted to their backs so that a server mounted on server rails may be pulled out from the front without disconnecting the cables. These servers require an additional four or five feet of cable. A need exists for a patch panel that takes up less space on a server rack.

### SUMMARY OF THE INVENTION

According to some aspects, the present invention provides patch panels that can be vertically oriented. By moving the patch panels to a vertical orientation, not only is space saved, but cabling is also simplified.

In certain embodiments, the present invention provides patch panels that include panels having a plurality of network ports for ingoing and outgoing lines of a communications system. The panels can have a vertical length that is greater than a horizontal width and can include a plurality of mounting holes for rack units oriented along the vertical length. The patch panels of the present invention are capable of being vertically mounted on a rack.

In certain embodiments, the present invention provides methods for connecting two or more devices mounted on a server rack. Methods of the present invention can include connecting one or more cords to a patch panel having a plurality of network ports and vertically mounting the patch panel to the server rack.

In certain embodiments, the present invention provides an apparatus that can include a panel having a plurality of network ports for communication lines of a computer system containing one or more servers, where the plurality of network ports can be grouped together in a set of blocks. In certain embodiments, the panel can include mounting fittings for vertically mounting the panel to a server rack and mounting holes for rack units capable of being oriented along a vertical length of the panel where the vertical length of the panel is greater than a horizontal width of the panel. In certain embodiments the patch panel may include a hinge to allow for access to the rear of the panel after mounting.

### BRIEF DESCRIPTION OF THE DRAWINGS

Each of the figures diagrammatically illustrates aspects of the invention. The illustrations provide examples of the invention as described herein. Combinations of the aspects of specific variations or combinations of the specific variations themselves are within the scope of this disclosure.

FIG. 1A shows a front view of a vertical patch panel in accordance with certain embodiments of the present invention.

FIG. 1B shows a side view of a vertical patch panel in accordance with the embodiment of FIG. 1A.

FIG. 1C shows a reverse view of a vertical patch panel in accordance with the embodiment of FIG. 1A.

FIG. 1D is a perspective view of a vertical patch panel in accordance with the embodiment of FIG. 1A.

FIG. 2A shows a front view of a vertical patch panel having cable guides in accordance with certain embodiments of the present invention.

FIG. 2B shows a side view of a vertical patch panel having cable guides in accordance with the embodiment of FIG. 2A.

FIG. 2C shows a reverse view of a vertical patch panel having cable guides in accordance with the embodiment of FIG. 2A.

FIG. 3 shows a front view of two server racks and a single vertical patch panel mounted on one of the server racks in accordance with certain embodiments of the present invention.

FIG. 4A shows a horizontal patch panel of the prior art mounted on a server rack with a series of 1U rackmount servers and sample cabling.

FIG. 4B shows a vertical patch panel mounted to a server rack with a series of 1U rackmount servers and sample cabling in accordance with certain embodiments of the present invention.

FIG. 4C is a perspective view of the vertical patch panel and server rack of FIG. 4B.

FIG. 5 is a view of a vertical patch panel with a hinge in accordance with certain embodiments of the present invention.

### DETAILED DESCRIPTION

A vertical patch panel, according to certain embodiments of the present invention, includes a plurality of network ports in a vertically oriented panel. The patch panel can be mounted vertically on the side of a server rack such that the patch panel can service all of the servers in the server rack. Changing the layout of the patch panel from horizontal to vertical, as in the invention, provides several advantages. A vertical patch panel that spans the length of the server rack simplifies cabling. The access to ports is moved closer to the servers. Shorter cabling is required, providing an overall cost savings as well as aesthetic benefits. By moving the patch panel to a vertical plane, a minimum of two rack units in the rack are saved. That is, a horizontal patch panel takes up two or more rack units, whereas the vertical patch panel does not take up any rack units space in the rack server.

Environment for Use of Patch Panel

The patch panel of the invention can be mounted to a rack for servers. A server can generally be a device (e.g., a computer) on a network that manages network resources, although the patch panel of the invention can be used for servers having different functionality as well. For example, a file server is a computer and storage device dedicated to storing files. Any user on the network can store files on the server. A print server is a computer that manages one or more printers, and a network server is a computer that manages network traffic. A database server is a computer system that processes database queries. Servers are often dedicated, meaning that they perform no other tasks besides their server tasks. On multiprocessing operating systems, however, a single computer can execute several programs at once. A server in this case could refer to the program that is managing resources rather than the entire computer.

A patch panel is generally a panel of ports contained together that connects incoming and outgoing communication lines of a communication system. For example, in a LAN, the patch panel can connect the network's computers to each other and to the outside lines that enable the LAN to connect to the Internet or another WAN. Connections can generally be made with patch cords and the patch panel allows circuits to be arranged and rearranged by plugging and unplugging the patch cords.

The connecting of servers via patch panels to backend switches can simplify the network architecture and reduce latency in servers through cross switch traffic. It is generally considered to be cleaner and more efficient than other methods of connection. While smaller server farm implementations may require a single or a couple of switches to connect all the servers, larger server infrastructures require significantly more switches.

An exemplary case can be 240 servers, with each of these servers having two network interfaces. The 240 servers can be divided into ten server racks. Hence, each rack contains 24 servers. Each rack can have one 48-port switch that connects each of the servers on both ports. Each of these switches can be connected to a gigabit switch having at least 10 ports. For the purpose of this example, a common three-tiered architecture of servers can be utilized. This three-tiered architecture includes database servers that store information, application servers that perform complicated tasks, and front-end web servers that interface between the end user and the application or database servers. In this example, 24 of the 240 servers can be the database servers, 108 servers can be the application servers, and 108 servers can be the front-end web servers. Each rack can have two or three database servers, ten or eleven application servers, and ten or eleven web servers. The number of types of servers in each rack can vary widely.

A request can come in to a web server located on a first rack, where the request can pass from the server through a switch on the first rack to the gigabit switch. The switch latency to hear the request can be about 0.2 ms (milliseconds). The gigabit switch can then pass the request off to an application server located on a second rack and to a switch located on the second rack. Now, a switch latency of 0.4 ms is introduced by passing through the two switches. This can be repeated on the receive end of the transaction, from the application server back to the front end web server for a total request time to simply establish initial communication between servers of 0.8 ms. This effort can further be duplicated to communicate with the database server located on a third rack with a third switch.

As shown above, the number of hops from one server to another server is at least two—a first hop from the switch of the first server to the gigabit switch and a second hop from the gigabit switch to the second switch on which the target server is located. When this latency is multiplied by millions of requests, the lag in response can be increased by the millions. This latency can lead to slower response times and fewer requests being honored because the servers are constantly waiting for responses from one another. Eventually more machines must be implemented to compensate for the latency. Additionally, such latency from an end-user perspective (the end user being a user attempting to access the servers) results in slower load times, such as the loading of a web page in the prior example.

Patch panels can effectively reduce the number of switches in the system. Therefore, the number of hops can also be reduced. Instead of connecting to an intermediary switch at the top of each rack, a server can be connected to a patch panel that runs the server directly into a centralized switch. Using a large 480-port switch, all machines can be connected on both interfaces with half the latency and zero hops. Connections between servers can be handled directly on the switch and are thus more immediate.

Patch panels may be utilized in a wide variety of different systems. For example, patch panel can be utilized in a telecommunications closet, within the environs of a data center, or in other places. In certain embodiments, the patch panel can connect servers on a rack mount to switches or other network devices or any device utilizing a RJ-45 Ethernet jack.

An RJ-45 jack is a Registered Jack-45, which is an eight-wire connector used commonly to connect computers onto a local-area network (LAN), especially Ethernet. RJ-45 connectors look similar to the ubiquitous RJ-11 connectors used for connecting telephone equipment, but they are somewhat wider.

Vertical Patch Panel

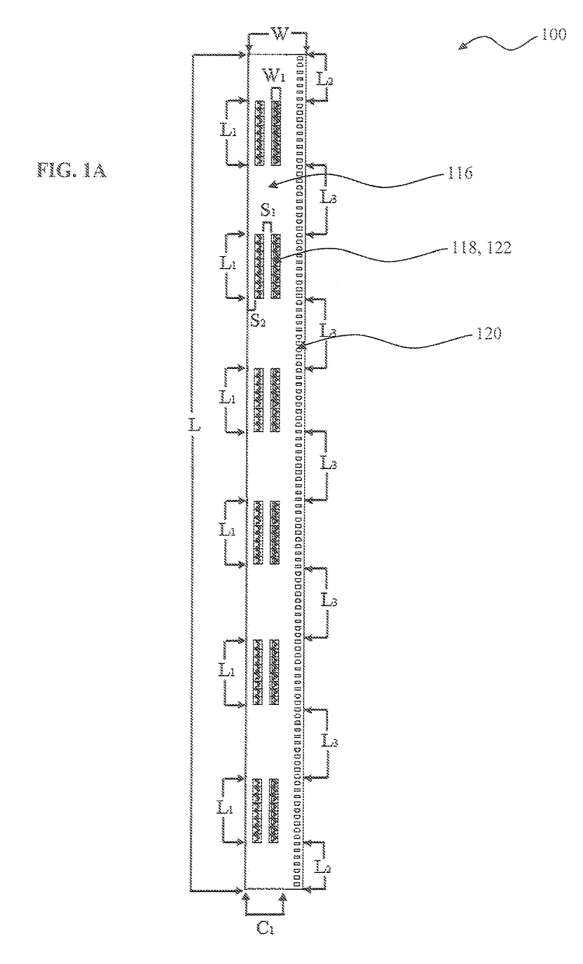

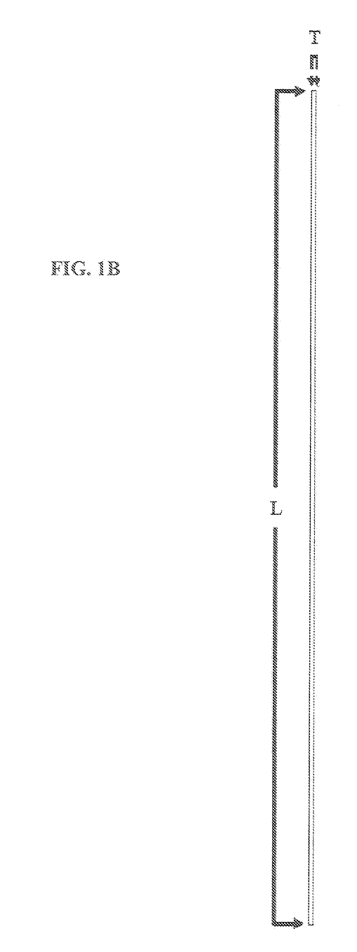

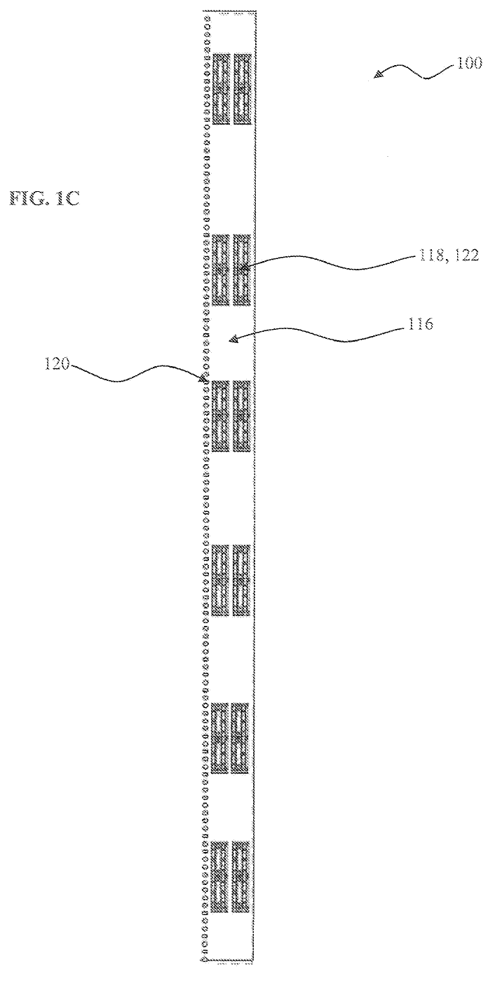

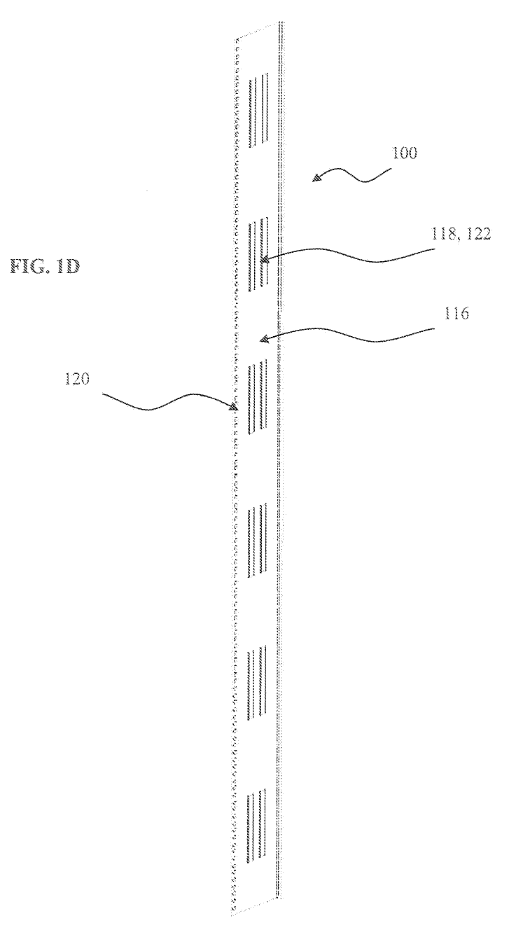

FIG. 1A shows a front view of vertical patch panel 100 in accordance with certain embodiments of the present invention. FIG. 1B shows a side view of the patch panel 100 shown in FIG. 1A, FIG. 1C is a reverse view, and FIG. 1D is a perspective view of the vertical patch panel 100. All of the dimensions described in this application are exemplary, and these dimensions can vary within the scope of the invention, as will be readily apparent to one of ordinary skill in the art. All measurements are represented in inches.

In certain embodiments, the height L of vertical patch panel 100 can be about 72 inches (i.e., 6 feet) and the width W can be about five inches. In other embodiments, the height L of the vertical patch panel 100 can be at least 12 inches. The depth or thickness T of the vertical patch panel 100 can also vary. For example, the left edge as well as a section of the top and bottom of the panel can be curved. The depth or thickness T of the vertical patch panel along the curved edge can be about 7/16 inches. The thickness of the strip 116 in the center of the patch panel 100, which holds the various punch-down blocks 118, can be about 1/16 inch. Thus, the patch panel 100 can vary in thickness between the edges and the center.

The height L, width W, and depth T of vertical patch panel 100 can be varied as needed. For example, when vertical patch panel 100 is utilized in a home or office setting, the measurements may be adjusted as needed. For example, height L can be 12 inches, width W may be about 5 inches, and depth T of the curved edges can be about 7/16 of an inch while the thickness T on the opposing face (center) can be about 1/16 of an inch.

Moreover, curved edges on the top and bottom of panel 100 can extend 3.25 inches from the left edge of panel 100 on both the top and bottom (C₁). On the right side of patch panel 100 are shown a series of 123 oval holes 120. The holes 120 in strip 116 can be arranged vertically in repeating sets of three, with center-to-center separations of 0.5 inch (12.7 mm), 0.625 inch (15.875 mm), 0.625 inch (15.875 mm). Therefore, the hole pattern can repeat every 1.75 inches (44.45 mm). The number of holes and the repetition patterns can vary within the scope of the invention, with the numbers set forth above being exemplary for one embodiment.

The holes 120 can represent 41U (that is, the height of 41 rack units). In a server rack having 42U, this can allow the vertical patch panel 100 to be mounted to the server rack with 1U or 1.75 inches remaining at either the top or bottom of the server rack.

The vertical patch panel 100 can be made from metal, although other materials can also be used. As described above, the vertical patch panel 100 has a height L that is substantially greater than the width W. During use, this allows the vertical patch panel 100 to be mounted on the side of a server rack and to service the entire server rack with cables of common length.

In certain embodiments, after connecting the required cables in the vertical patch panel 100, the vertical patch panel 100 can be mounted to one or more racks. For example, vertical patch panel 100 can be mounted via holes 120 that correspond to the spacing of a single rack unit. The vertical patch panel 100 can be mounted on the side of a rack. In addition, the vertical patch panel 100 can be mounted externally to the rack so that the vertical patch panel 100 does not take up any space in the interior of the rack.

Strip 116 can also have twelve rectangular holes 122 where the punch-down blocks 118 can be mounted (shown in FIGS. 1A and 1C filled in with punch-down blocks 118). The rectangular holes 122 can measure 5.50 inches long (L₁) by 1 inch wide (W₁) and can be paired up with six sets of punch-down block pairs (i.e., there are a total of 12 punch down blocks 118). The punch-down block pairs can be spaced (S₁) about 0.8125 inches apart and can be about 0.5 inches from the left side (S₂) of the vertical patch panel 100. Beginning 3.75 inches (L₂) from the top of the vertical patch panel 100, they can repeat every 6.25 inches (L₃), with the last punch-down block 118 about 3.75 inches (L₂) from the bottom of vertical patch panel 100. The dimensions of W₁, L₁, L₂, L₃ can vary within the scope of the invention, with the numbers set forth above being exemplary for one embodiment.

In certain embodiments, punch-down blocks 118 can contain about 8 ports, which may be an industry standard 8 port punch-down block. This can reduce overall cost of the invention as customers may select the type of punch down block 118 used. In certain embodiments, the ports can be RJ-45 jack ports and can be located in the front of vertical patch panel 100. The punch-down block 118 can use a variety of RJ-45 cables, including Category 5 (Cat5), Category 5-Enhanced (Cat5-E), or Category 6 (Cat6). In certain embodiments, vertical patch panel 100 can contain about 8×2×6=96 ports, but the total number of ports can be changed as needed. For example, in the embodiment of FIGS. 1A through 1D, each punch-down block 118 contains 8 ports, the punch-down blocks are in groups of 2, and there are 6 groups of punch down blocks.

Other utilizations of the patch panels include, but are not limited to, the ability to utilize the RJ-45 jacks for additional functionality, whether it is for keyboard, video, and mouse or KVM over Ethernet or to connect to management devices such as serial consoles or IPMI devices. The port density on the vertical patch panel 100 allows for many possibilities in configuration and usage. In one embodiment, the network ports are not precisely vertically oriented, but remain in a predominantly vertical orientation. Thus, the network ports need not be exactly vertically oriented, which permits variation in port density and alignment. Altering the orientation of the network ports can reduce the amount of cable necessary to connect devices to the patch panel.

FIG. 1C shows the reverse side of vertical patch panel 100. The left, top, and bottom of the patch panel can have curved edges, as described above. FIG. 1C also shows the reverse side of punch-down blocks 118. This is the side that may be cabled, and the cables can run to the complimentary patch panel elsewhere (not shown). Beginning 3.75 inches (L₂) from the top of the patch panel 100, punch-down blocks 118 can repeat every 6.25 inches (L₃), with the last two punch-down blocks 118 about 3.75 inches from the bottom of vertical patch panel 100.

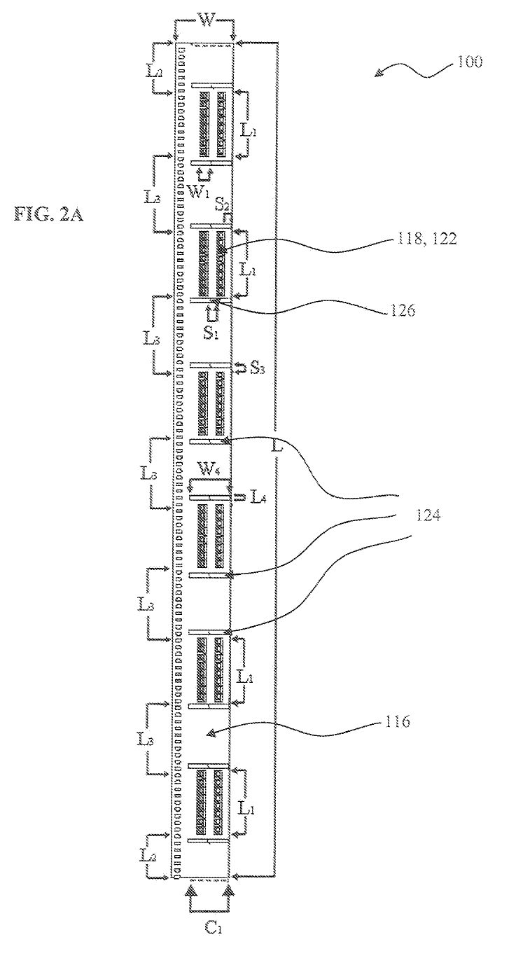

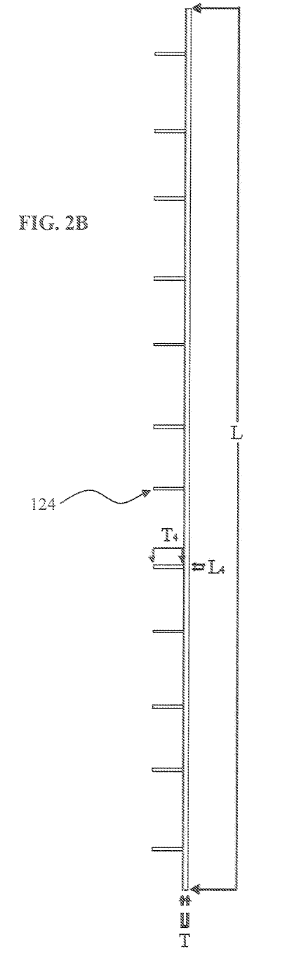

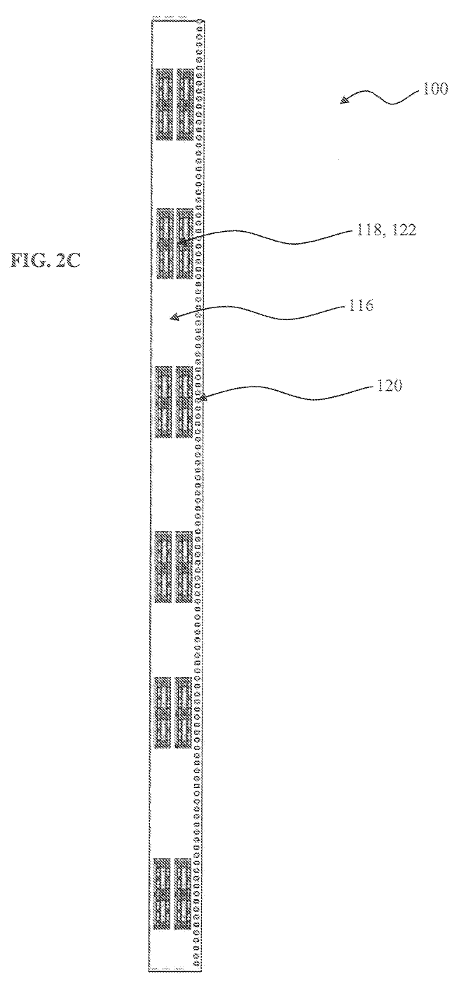

FIGS. 2A through 2C show vertical patch panel 100 in accordance with other embodiments of the present invention that use cable guides 124. As shown, FIG. 2A shows vertical patch panel 100 from the front view, FIG. 2B shows vertical patch panel 100 from the side view, and FIG. 2C shows vertical patch panel 100 from the reverse view. Much like FIGS. 1A through 1C, the height L of vertical patch panel 100 can be about 72 inches (i.e., 6 feet) and the width W can be about five inches. In other embodiments, the height L of the vertical patch panel 100 can be at least 12 inches. Depth or thickness T of the vertical patch panel 100 can also vary. For example, the left edge as well as a section of the top and bottom of the panel can be curved about 3.25 inches (C₁). The depth or thickness T of the vertical patch panel along the curved edge can be about 7/16 of an inch. The thickness of the strip 116 in the center of the patch panel, which holds the various punch-down blocks 118, can be about 1/16 of an inch. Thus, the patch panel can vary in thickness between the edges and the center.

The height H, width W, and depth T of vertical patch panel 100 can be varied as needed. For example, when vertical patch panel 100 is utilized in a home or office setting, the measurements may be adjusted as needed. For example, height H can be 12 inches, width W may be about 5 inches, and depth T of the curved edges can be about 7/16 inches while the thickness T on the opposing face (center) can be about 1/16 inch. The dimensions of W, L, and T can vary within the scope of the invention, with the numbers set forth above being exemplary for one embodiment.

Strip 116 can also have twelve rectangular holes 122 where the punch-down blocks 118 can be mounted (shown in FIGS. 1A and 1C filled in with punch-down blocks 118). The rectangular holes 122 can measure 5.50 inches long (L₁) by 1 inch wide (W₁) and can be paired up with six sets of punch-down block pairs (i.e., there are a total of 12 punch down blocks 118). The punch-down block pairs can be spaced (S₁) about 0.8125 inches apart and can be about 0.5 inches from the right side (S₂) of the vertical patch panel 100. Beginning 3.75 inches (L₂) from the top of the patch panel 100, they can repeat every 6.25 inches (L₃), with the last punch-down block 118 about 3.75 inches (L₂) from the bottom of vertical patch panel 100. The dimensions of W₁, L₁, L₂, and L₃ can vary within the scope of the invention, with the numbers set forth above being exemplary for one embodiment.

As shown, vertical patch panel 100 can further include cable guides 124. In this embodiment, each pair of punch down blocks 118 can be accompanied by a pair of cable guides 124. For example, as shown in FIGS. 2A through 2C, one cable guide 124 can be provided above a pair of punch down blocks 118, and one cable guide 124 can be provided below the pair of punch down blocks 118. Hence, a total of 12 cable guides 124 can be provided in vertical patch panel 100. In certain embodiments, the distance (S₃) between punch down block 118 and cable guide 124 can be about 0.5 inches. Cable guide 124 can be a metal rectangle measuring 3.75 inches wide (W₄), 0.25 inches high (L₄), and 3 inches deep (T₄). There can be a 0.75 inch angled gap 126 on the top facing section of guide 124. Cables may be run through the break in cable guide 124 themselves. The dimensions of S₃, W₄, L₄, and T₄ can vary within the scope of the invention, with the numbers set forth above being exemplary for one embodiment.

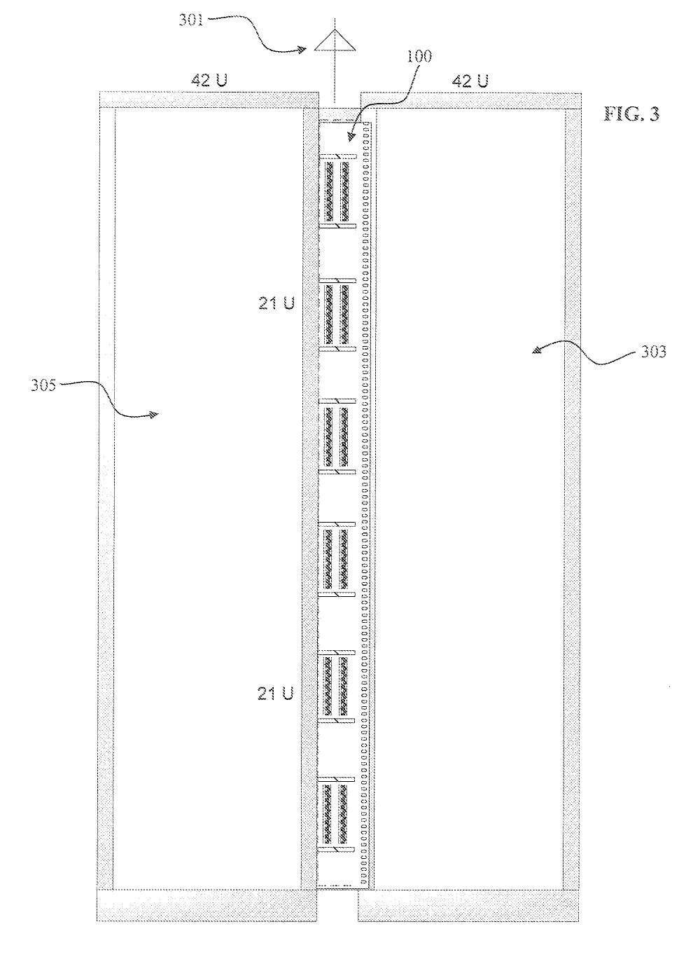

FIG. 3 shows a front view of two server racks 303, 305 and a single vertical patch panel 100. In FIG. 3, vertical patch panel 100 is mounted only to the server rack 303. In this particular embodiment, the vertical patch panel 100 can serve both server racks 303 and 305. In other embodiments, only a single server rack, such as server rack 303, is served by the vertical patch panel 100. In still other embodiments, the vertical patch panel 100 could be mounted to both server racks 303, 305. Vertical patch panel 100 can mount on either the right or the left post of a server rack, without being mounted on both posts. As explained above, in FIG. 3, the vertical patch panel is mounted to server rack 303 on the right.

The server racks shown in FIG. 3 are 79 inches in height, which can correspond to a standard rack height of 42U. The spacing between the racks can be 5 inches and can be covered by patch panel 100. S₁Since patch panel shown in FIG. 3 is 41U in height, the space of 1U was allocated to the top of the rack.

In a horizontal mount patch panel, the cable bundles connecting the patch panel to the patch panel on the server row are typically bundled over the rack and run on ladder racks to their destination.

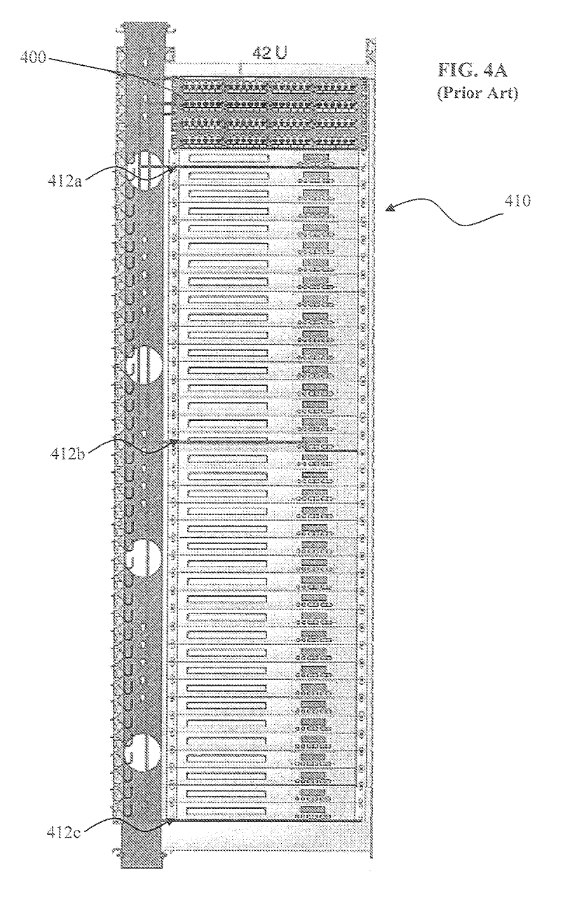

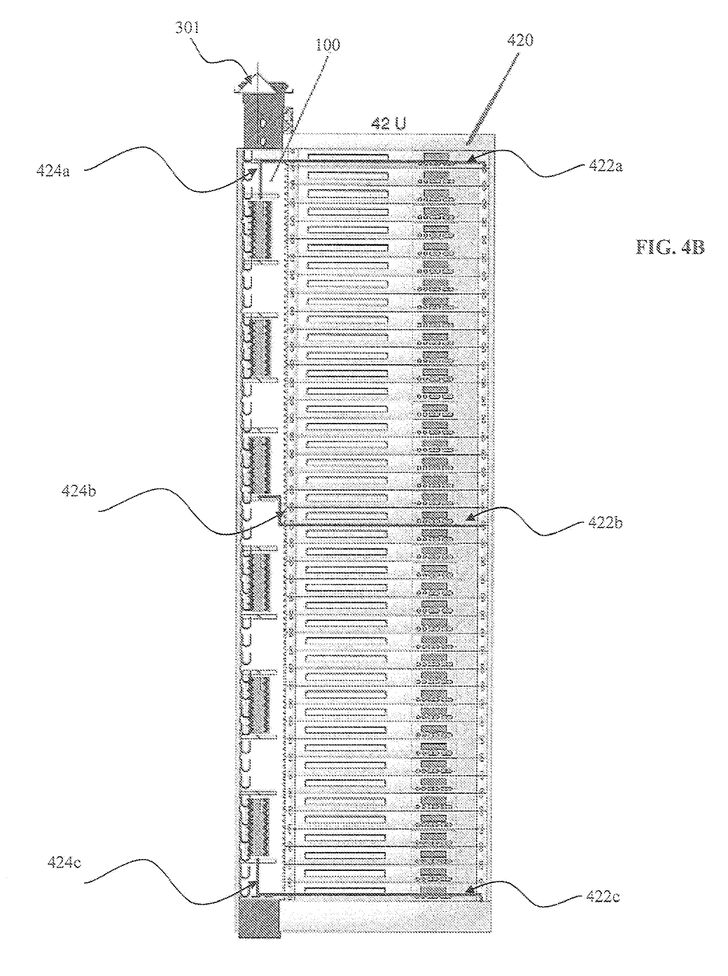

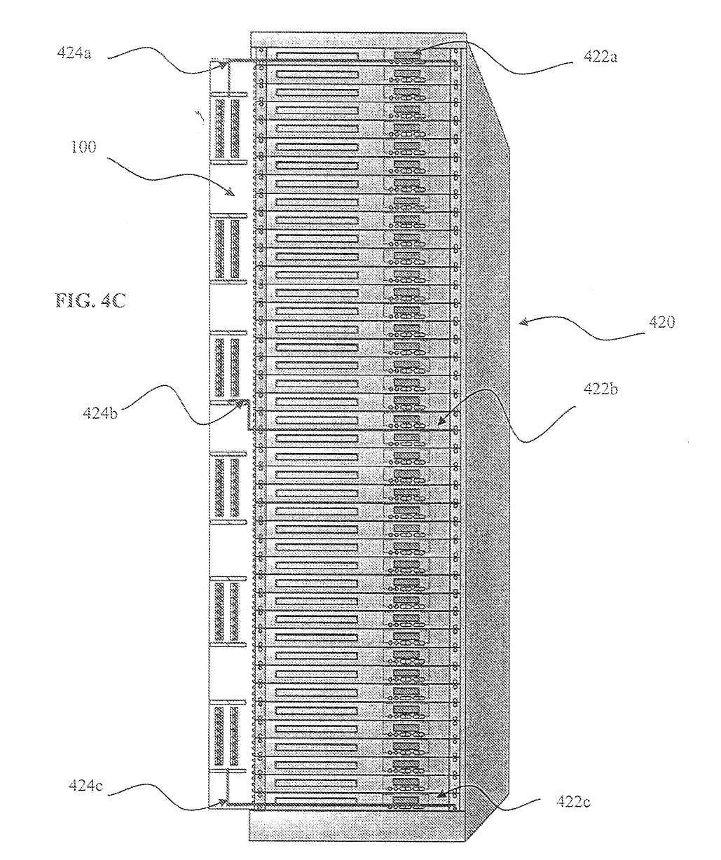

The cable symbol 301 in FIGS. 3 and 4B illustrates the location where the bundle of cables is run from the rear of patch panel 100. The manner in which the cables are mounted can be unique to this design. In particular, the cables can be bunched together in the space behind the vertical patch panel 100 and oriented in a vertical fashion so that these cables can be fed into or out of the server rack through the opening at the top where the cable symbol 301 is shown.

In the vertical patch panel 100 of the invention, the patch cables can be bundled, gradually building up to a top bundle that is then run to the bundle at the top. As this is mounted in a semi-permanent fashion, the installer does not need to run all the bundled wire; they may opt to just run the pairs of wires that are necessary without the cable shielding. This would reduce the size in back of the panel. Once mounted, the patch panel is intended to remain undisturbed until such a time as the owner no longer needs it. The patch panel may be upgraded by replacing the punch-down blocks. Since the punch-down blocks can be available as a standard part, in a standard form factor, this can be done without having to replace the shell of the patch panel.

FIG. 4A shows a conventional horizontal patch panel 400 on server rack 410. On server rack 410 there is a horizontal patch panel 400 that measures 4 rack units (4U) in height. Underneath this horizontal patch panel 400 are 38 1U servers. FIG. 4A also shows cabling by the lines connecting three servers on rack 410 to horizontal patch panel 400. For example, on rack 410 using the horizontal patch panel, top server 412a, middle server 412b and lowest server 412c, have been connected to horizontal patch panel 400.

The cable lengths for connecting servers 412a, through 412c, to horizontal patch panel 400 vary widely in length. The cable connecting the top server 412a, to horizontal patch panel 400 is approximately 3 feet in length. However, the cable connecting server 412b, to horizontal patch panel 400 can be about 5.5 feet in length, and the cable connecting server 412c to horizontal patch panel 400 can be about 9.5 feet in length. Thus, when a horizontal patch panel 400 is used with a server rack, cable lengths can vary widely.

Much like FIG. 3, FIGS. 4B and 4C show a vertical patch panel 100 mounted to server rack 420. In server rack 420, 42 1U servers are connected to the vertical patch panel 100. By shifting the location of the patch panel to a vertical orientation at least 4U in space was gained, allowing four additional 1U servers to be mounted in server rack 420.

FIG. 4B also shows cabling by the lines connecting three servers on rack 420 to vertical patch panel 100. The lengths of the cables 42a-424c connecting servers 422a-422c to vertical patch panel 100 on rack 420 are substantially equal (e.g., each is under three feet in length) regardless of location. For example, each of servers 422a, 422b, and 422c, uses a cable length of about 3 feet to connect to ports on the vertical patch panel 100. This is one of the advantages of vertical patch panel 100 over a horizontal patch panel 400.

Hence, by moving the patch panels to a vertical orientation, not only is space saved, but cabling is simplified. The ports can be brought closer to the servers and can eliminate the need for cables of differing lengths because all the cables are substantially equidistant from the ports of the vertical patch panel to the port on the server. This can reduce overall cost of cabling because shorter cables cost less money and the number of cables of the same type increases. This can simplify management in that only one type of cable needs to be stocked. Moreover, because the servers' cabling can look the same, it also has an added benefit of providing improved aesthetics. Additionally, if the network ports are not precisely vertically oriented, but have a slightly slanted orientation, the required cable lengths can be further standardized and the amount of cabling further reduced.

The number of servers on the racks 410 and 420, if fully stocked, can also differ. In rack 410 having horizontal patch panel 400, shown with no additional cable guides, no more than 38 servers can be installed in the illustrated embodiment. However, in rack 420 having vertical patch panel 100, 42 servers can be installed.

Moreover, conventional horizontal patch panel 400 is essentially composed of four 24 port horizontal strips and is designed to be mounted on two posts of server rack 410. However, vertical patch panel 100 can be designed to be mounted on just one post of rack server 420.

In addition, mounted cable spacers (through which cables can be run) were provided between servers (typically spaced apart at least about 5 inches) in the prior art. In the present invention, however, there is no need for running cables through these spacers because the cables can go directly to the devices. Hence, the spaces between the servers can be utilized to run the patch cables that connect the patch panels to the centralized patch panels where the switch or switches are connected.

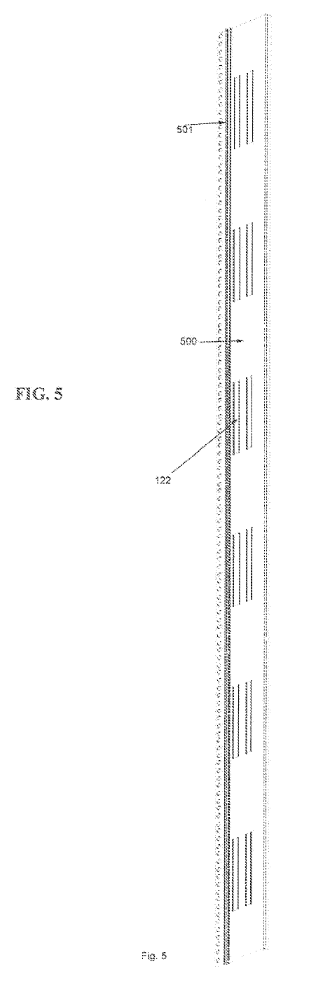

FIG. 5 shows a front view of a vertical patch panel 500 including a hinge 501 in accordance with certain embodiments of the present invention. All of the dimensions described in this application are exemplary, and these dimensions can vary within the scope of the invention, as will be readily apparent to one of ordinary skill in the art. All measurements are represented in inches.

In an embodiment, the vertical patch panel 500 also includes a hinge 501 oriented along the length L of the vertical patch panel 500. When the vertical patch panel 500 is mounted on the side of a server rack, or other rack, the hinge 501 allows adjustment of the vertical patch panel 500 relative to the server rack, or other rack, to be adjusted. This allows easier access to the vertical patch panel 500 while reducing reduce the area necessary to house the combination of server rack and the vertical patch panel 500. Hinge 501 can also reduce the amount of space necessary for the vertical patch panel 500 by allowing it to be adjusted so it protrudes less than its full width W from the server rack, or other rack. Additionally, hinge 501 allows for easier access to the rear of the vertical patch panel. In other embodiments, the vertical patch panel 500 includes multiple hinges oriented along the length L to adjust position relative to the server rack or other device. In alternative embodiments, the vertical patch panel 500 includes both a hinge 501 oriented along length L and a cable guide 124.

The vertical patch panels of the present invention reduce cable lengths, simplify design layouts, increase port density, provide enhanced aesthetics due to symmetry of cabling, and significantly reduce costs of ownership. Moreover, the present invention has the added benefit of providing a flexible design as different types of punch-down blocks (such as Cat5 or Cat6) can be specified at any time. For example, punch-down blocks can be replaced to any desired port types at any time.

Upon review of the description and embodiments of the present invention, those skilled in the art will understand that modifications and equivalent substitutions may be performed in carrying out the invention without departing from the scope of the invention. Thus, the invention is not meant to be limited by the embodiments described explicitly above, and is limited only by the claims that follow.

1. A patch panel comprising:
a panel having a plurality of network ports for ingoing and outgoing lines of a communications system, the panel having a vertical dimension that is greater than a horizontal dimension and the panel including a plurality of mounting holes for rack units oriented along the vertical length, wherein the panel is capable of being vertically mounted on a rack and is capable of servicing a plurality of rack units; and
a hinge oriented along a vertical length of the panel for adjusting a position of the panel.

2. The patch panel of claim 1, further comprising one or more cable guides for redirecting one or more cables.

3. A method for connecting two or more devices mounted on a server rack, the method comprising:
connecting one or more cables to a patch panel comprising a plurality of network ports and a hinge oriented along a vertical length of the patch panel; and
vertically mounting the hinge of the patch panel to the server rack so that the patch panel can service a plurality of servers in the server rack.

4. The method of claim 3, wherein the patch panel further comprises one or more cable guides for redirecting one or more cables.

5. An apparatus comprising:
a panel having a plurality of network ports for communication lines of a computer system containing one or more servers, the plurality of network ports being grouped together in a set of blocks, wherein a vertical length of the panel is greater than a horizontal width of the panel; and
a hinge oriented along the vertical length of the panel for adjusting the position of the panel, wherein the hinge includes mounting fittings for vertically mounting the panel to a server rack.

6. The apparatus of claim 5, further comprising one or more cable guides for redirecting one or more cables.

7. A patch panel comprising:
a panel having a plurality of network ports for ingoing and outgoing lines of a communications system, the panel having a vertical dimension that is greater than a horizontal dimension and the panel including a plurality of mounting holes for rack units oriented along the vertical length, wherein the panel is capable of being vertically mounted on a rack and is capable of servicing a plurality of rack units; and
at least one cable guide, connected to the panel, for redirecting at least one cable.

8. A method for connecting two or more devices mounted on a server rack, the method comprising:
connecting one or more cables to a patch panel comprising a plurality of network ports and a cable guide, connected to the patch panel, for directing one or more cables; and
vertically mounting the hinge of the patch panel to the server rack so that the patch panel can service a plurality of servers in the server rack.

9. An apparatus comprising:
a panel having a plurality of network ports for communication lines of a computer system containing one or more servers, the plurality of network ports being grouped together in a set of blocks, wherein a vertical length of the panel is greater than a horizontal width of the panel; and
at least one cable guide, for directing one or more cables.
